(19) United States
(12) Patent Application Publication
(10) Pub. No.: US 2018/0292133 A1
(43) Pub. Date: Oct. 11, 2018

(54) HEAT TREATING FURNACE

(71) Applicant: REX MATERIALS GROUP, FOWLERVILLE, MI (US)

(72) Inventors: Tim Vondemkamp, Denton, TX (US); Steve Schenck, Howell, MI (US)

(21) Appl. No.: 15/479,865

(22) Filed: Apr. 5, 2017

(51) Int. Cl. F27D 1/00; F27B 17/00

(52) U.S. Cl. CPC F27D 1/0033; F27D 1/0036; F27B 17/0025

(57) ABSTRACT

A heat treating furnace of the type used in semiconductor manufacturing having a housing with a tubular and cylindrical inner layer constructed of ceramic fiber. Electrical heating elements are supported by the inner layer while a microporous silica layer surrounds and is in contact with the ceramic fiber layer. A rigid cover surrounds the microporous silica layer.

### BACKGROUND OF THE INVENTION

### I. Field of the Invention

The present invention relates generally to heat treating furnaces and, more particularly, to a heat treating furnace of the type used in semiconductor and solar cell manufacturing.

### II. Description of Related Art

There have been many previously known electric heat treating furnaces of the type particularly suited for manufacturing semiconductor electronic components. These furnaces typically are used for oxidation, diffusion of impurities into the semiconductor material and/or CVD of semiconductor wafers.

These previously known furnaces for manufacturing semiconductor wafers typically comprise an elongated tubular housing which defines an elongated tubular and cylindrical heating chamber. The furnace includes an inner ceramic layer which not only defines the chamber to receive the semiconductor wafers, but also physically supports electrical heating elements that are used to heat the chamber to the desired temperature.

During the manufacturing process for the semiconductors, thin semiconductor wafers are mounted in a carrier, also known as a boat, which fits within the interior chamber of the furnace. Consequently, with the boat containing one or more wafers positioned within the interior of the furnace, after heating the wafers to a selected temperature, typically in excess of 1300° F., an impurity is introduced into the oven chamber to “dope” the wafers by diffusion of the impurity into the semiconductor wafer. Certain dopants are used to dope the semiconductor wafer to a p+ material while other dopants are used to create an n− layer in the semiconductor wafers. The complete manufacture of any particular semiconductor component typically requires multiple treatments of the semiconductor wafer with p+ and n− gas in different patterns in order to complete the electronic component.

In order to obtain consistent and uniform diffusion of the p+ and n− materials into the semiconductor wafer, it is important to maintain the interior of the furnace at a uniform or substantially uniform temperature in order to achieve uniform diffusion of the doping material into the silicon wafer. In order to achieve a uniform or substantially uniform temperature in the furnace chamber, the previously known electric heaters typically include an insulation layer surrounding the ceramic inner layer of the furnace. This insulation has been achieved by utilizing a microporous insulation layer of hollow microspheres that are on the order of hundreds or even thousands of nanometers in diameter. Such an insulation layer, which is typically about 1 inch-1½ inch in thickness, has proven successful to maintain the required uniformity or near uniformity of temperature within the interior of the furnace.

Although these previously known insulation layers surrounding the ceramic inner layer of the furnace have proven adequate in maintaining substantial uniformity of temperature within the furnace, they nevertheless allow a significant amount of heat to escape through the insulation layer and furnace walls. As such, the rooms containing such semiconductor furnaces require extensive air conditioning in order to remove the lost heat from the furnaces. Indeed, the amount of heat lost by the previously known furnaces is so great that the number of furnaces that may be stacked upon each other is strictly limited due to thermal considerations. This, in turn, increases the overall manufacturing space and air conditioning requirements necessary during the semiconductor manufacture.

### SUMMARY OF THE PRESENT INVENTION

The present invention provides a furnace particularly suitable for manufacturing semiconductor components. In brief, like the previously known furnaces for manufacturing semiconductor materials, the furnace of the present invention includes a tubular and cylindrical inner layer constructed of ceramic fiber. The ceramic fiber is rigid and supports heating elements which, when energized, heat the cylindrical interior chamber of the furnace.

Unlike the previously known furnaces for manufacturing semiconductors, the inner ceramic layer is surrounded by a layer of microporous insulation. The microporous insulation is formed from fumed material having a particle size in the range of approximately 10-20 nanometers. These fumed particles, furthermore, are held together between two layers of heat resistant flexible material which is sewn or otherwise connected together.

The microporous layer surrounds the ceramic layer and, in turn, is surrounded by a tubular and cylindrical metal housing. As such, the furnace of the present invention comprises three layers, namely the ceramic fiber layer for insulation and supporting the electrical heating coils, the microporous insulation layer surrounding the ceramic layer and, finally, the metal housing surrounding the microporous layer.

Unlike the previously known furnaces, the microporous layer is formed from solid particles preferably made of fumed silica. The spacing between the individual particles is such that the spacing is less than the mean free path of the movement of air molecules. As such, the microporous insulation layer provides enhanced insulation for the semiconductor manufacturing furnace without increasing the overall size of the furnace.

### BRIEF DESCRIPTION OF THE DRAWING

A better understanding of the present invention will be had upon reference to the following detailed description when read in conjunction with the accompanying drawing, wherein like reference characters refer to like parts throughout the several views, and in which:

FIG. 1 is an elevational view illustrating a furnace of a preferred embodiment of the present invention;

FIG. 2 is an elevational sectional view;

FIG. 3 is a fragmentary view of the heating coils; and

FIG. 4 is a cross-sectional view with parts removed for clarity.

### DETAILED DESCRIPTION OF A PREFERRED EMBODIMENT OF THE PRESENT INVENTION

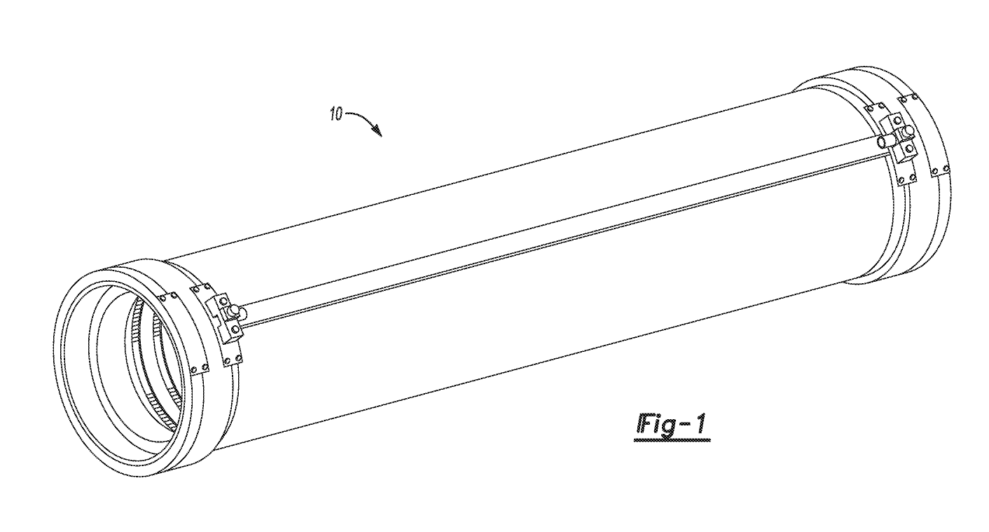

With reference first to FIGS. 1 and 4, an electrical furnace 10 of the type used for the manufacturing of semiconductor materials is shown. The furnace 10 includes an elongated cylindrical chamber 14 surrounded by an insulation tube 15, typically made of quartz, dimensioned to receive one or more trays or “boats” of semiconductor wafers so that all of the wafers are positioned within the interior of the furnace 10.

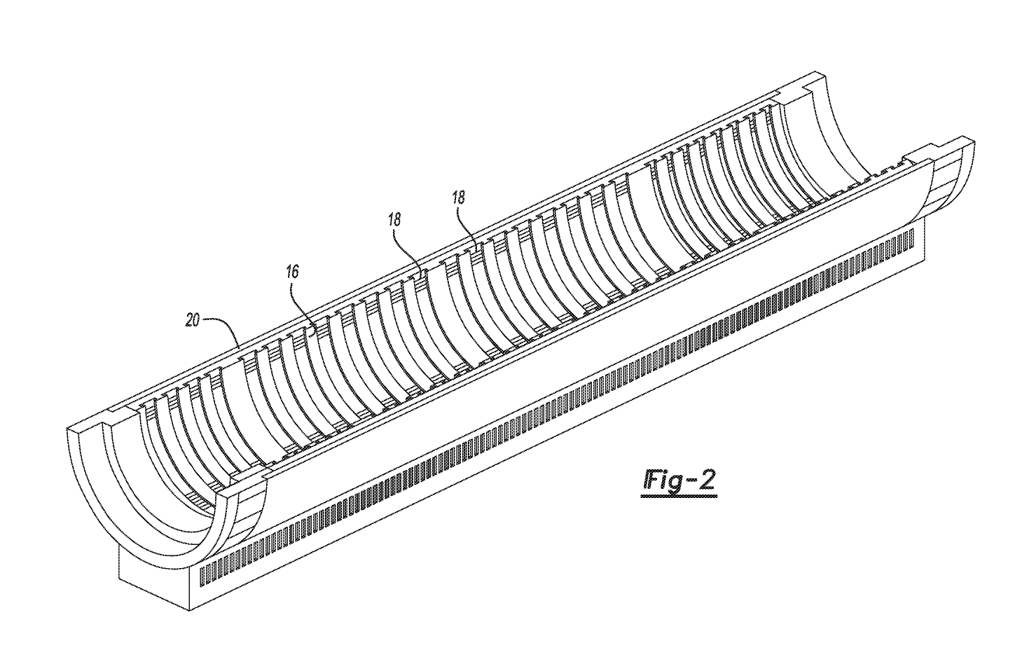

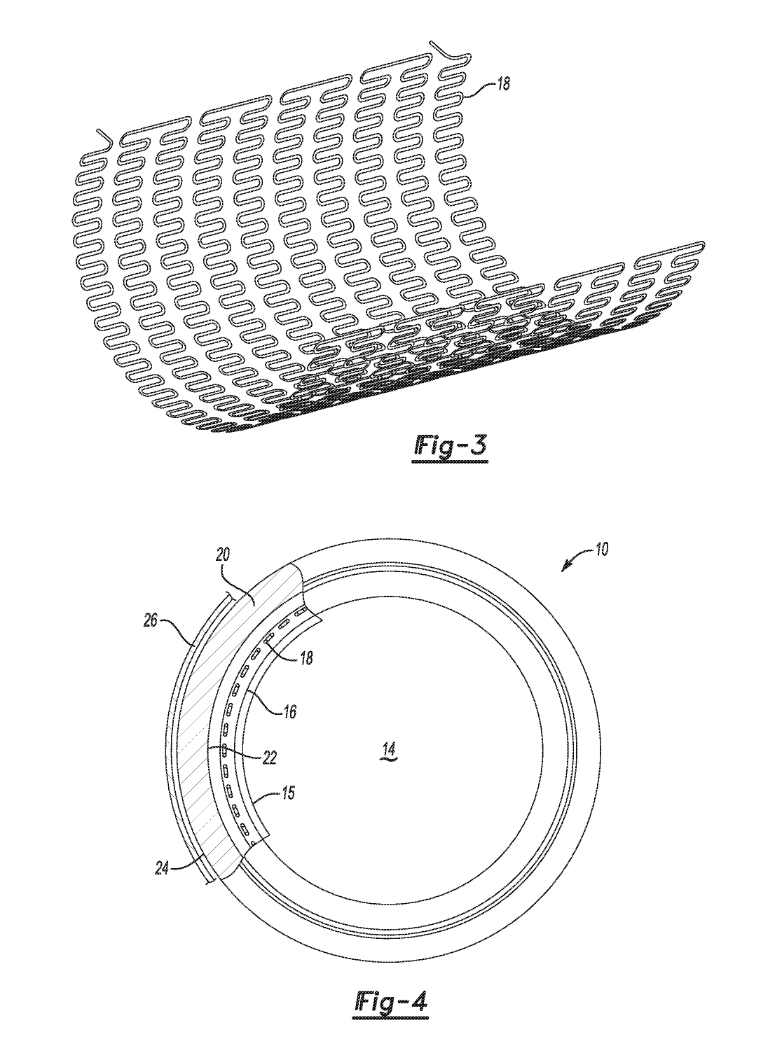

As best shown in FIGS. 2-4, a ceramic fiber inner layer 16 surrounds the furnace chamber 14. The ceramic fiber 16 is rigid in construction and supports a plurality of electrical heating elements 18 which are open to the chamber 14. Consequently, once the electrical heating elements 18 are connected to a source of electrical power, the heating elements heat the interior chamber 14 of the furnace 10 to the desired temperature necessary to process semiconductor wafers positioned within the furnace chamber 14. Furthermore, the ceramic fiber layer 16 and the electrical heating elements 18 are conventional in construction. As such, further description thereof is unnecessary.

With reference now particularly to FIGS. 2 and 4, the ceramic fiber layer 16 is surrounded by an insulation layer 20. As used herein, the terms “microporous insulation” includes insulation materials comprising compacted powder or fibers with an average interconnecting pore size comparable to or below the mean free path of air molecules at standard atmospheric pressure. Microporous insulation may contain opacifiers to reduce the amount of radiant heat transmitted. Microporous insulation describes insulation materials having pores which are generally less than 100 nm in size. The insulation layer 20 is constructed from fumed silica so that the silica particles are solid in cross section. The fumed silica, furthermore, has a mean particle size of approximately 10 nanometers. Consequently, close spacing between adjacent particles results in particle spacing less than the mean free path of air molecules. This, in turn, greatly reduces air-to-air conduction of heat through the insulating layer 20.

With reference to FIG. 4, the fumed particles which form the insulation layer 20 are weakly bonded together and friable in nature and do not adhere to each other. Consequently, in order to maintain the fumed silica particles within the layer 20, the fumed silica particles are sandwiched between two mats 22 and 24 constructed of a heat insulating material. Preferably, the two insulation retaining layers 22 and 24 are stitched together in a quilted pattern thus maintaining a substantially even distribution of the fumed silica particles within the mat 20 around the entire circumfery of the furnace chamber 14.

The layer 20 of fumed silica particles is then covered by a thin, rigid metal cover 26 which extends entirely around the furnace. The heating coils 18 are then connected to electrical power through electrical connections formed through the furnace in any conventional fashion.

In practice, the fine solid particles formed from fumed silica forming the outer layer 20 of insulation for the furnace effectively reduce the air-to-air heat conduction through the insulating layer 20. This, in turn, retains more heat within the interior of the furnace thus reducing power consumption of the furnace in use. Furthermore, since the transfer of heat radially outwardly from the treatment chamber 14 is reduced, the outer temperature of the outer metal housing for the furnace 10 is cooler than the previously known furnaces of the same size. This, in turn, reduces the energy consumption and equipment necessary to remove heat from the outside of the furnace during operation of the furnace and, particularly, when multiple furnaces are contained within the same building portion.

From the foregoing, it can be seen that the present invention provides a simple yet effective furnace for manufacturing semiconductor components. Having described my invention, however, many modifications thereto will become apparent to those skilled in the art to which it pertains without deviation from the spirit of the invention as defined by the scope of the appended claims.

I claim:

1. A heat treating furnace comprising
a tubular and cylindrical inner layer constructed of ceramic fiber;
heating elements supported by radially inner portion of said inner layer;
microporous silica layer surrounding said ceramic fiber layer, the silica layer including solid particles having a spacing between particles less than the mean free path of movement of air particles;
a rigid cover in contact with and surrounding said silica layer.

2. The invention as defined by claim 1 wherein said microporous silica layer comprises a pair of radially spaced apart and parallel mats constructed of heat resistant material and microporous silica contained between said mats.

3. The invention as defined by claim 2 wherein said mats are sewn together.

4. The invention as defined by claim 1 wherein said cover is constructed of metal.

5. The invention as defined by claim 4 wherein said cover comprises stainless steel.

6. (canceled)

7. The invention as defined by claim 6 wherein the particle size of said silica solid particles is in the range of 1-65 nanometers.

8. The invention as defined by claim 7 wherein said particle size of said silica solid particles is in the range of 10-20 nanometers.

9. The invention as defined by claim 8 wherein said particle size of said silica solid particles is about 10 nanometers.
